(19) United States
(12) Patent Application Publication
(10) Pub. No.: US 2022/0244848 A1
(43) Pub. Date: Aug. 4, 2022

(54) SYSTEM AND METHOD FOR PERFORMING SEARCH

(71) Applicant: Eric Robert Anderson, Tuckerton, NJ (US)

(72) Inventor: Eric Robert Anderson, Tuckerton, NJ (US)

(21) Appl. No.: 17/592,868

(22) Filed: Feb. 4, 2022

Related U.S. Application Data
(60) Provisional application No. 63/145,861, filed on Feb. 4, 2021.

(51) Int. Cl. G06F 3/0489; G06F 3/0482; G06F 3/023; G06F 3/04847; G06F 16/9538; G06F 16/955

(52) U.S. Cl. CPC G06F 3/04897; G06F 3/0482; G06F 3/0236; G06F 2203/04803; G06F 16/9538; G06F 16/9566; G06F 3/04847

(57) ABSTRACT

A method is disclosed for performing a search on a search interface. To that end, the method obtains a search query from a user. Further, a user selection is obtained corresponding to a user interface element from a plurality of user interface elements. The user selection is performed on a keyboard based navigation, where each of the plurality of user interface elements is associated with a corresponding URL. Further, one or more results are generated for the search query based on the received user selection and the one or more results corresponding to the search query are displayed as output.

### CROSS-REFERENCE TO RELATED APPLICATION

This application claims priority from U.S. provisional application No. 63/145,861, filed Feb. 4, 2021, the content of which are incorporated herein in the entirety by reference.

### TECHNOLOGICAL FIELD

The present disclosure is related to internet technology, and more particularly related to systems and methods for performing search conveniently using internet technology.

### BACKGROUND

Recent advancements in internet technology have led to development of various web searching engines. In present scenario, individuals have to perform online searching by opening a web search engine's home page and then typing search content to get the required search results. If the individual wants to perform repeated and multiple searches using different search engines, the process of typing a search query, hitting enter or performing mouse-click and checking search results, has to be repeated multiple times. This requires a lot of manual efforts of going back and forth on different search engines for the purpose of online search. However, for efficient web search, there is a need of a searching method where individuals can perform search with much less time and efforts. The same manual effort is also expended while doing offline searching on a computing device.

Accordingly, there is a need of a method that facilitates ease of search, specifically web-based search. An alternative search system is required to thereby provide a greater level of control and ease of use for users to perform efficient search.

### SUMMARY

Accordingly, it is an objective of some embodiments to provide a unique search method to perform easy and efficient search. To that end, the ease and effectiveness of search is needed to make efficient use of internet as a tool.

Some embodiments of the present disclosure provide a method for performing a search. The method comprises receiving user selection corresponding to a first user interface element from a plurality of user interface elements, where the user selection is performed via a keyboard based navigation. Further, the method comprises generating one or more results for the search query based on the received user selection and outputting the one or more results corresponding to the search query. Further, each of the plurality of user interface elements is associated with a corresponding URL.

In additional method embodiments, the search is performed by accessing a search interface by pressing a key of the keyboard device of the user. Further, the search interface comprises a search window to display information associated with the search query. Additionally, the key to the keyboard is “esc” key associated with the user device.

In additional method embodiments, the keyboard-based navigation is further based upon navigating using at least one of: an up arrow key, a down arrow key, a left arrow key, and a right arrow key; of the keyboard device associated with the user device. Further, a corresponding URL for navigation is configured by the user based on a settings user interface.

In additional method embodiments, a settings user interface further comprises configuration options associated with one or more of: a window length, a window width, and one or more advertising preferences.

In additional method embodiments, the plurality of user interface elements further comprises one or more of: a button, a label, and an icon. The plurality of user interface elements are further associated with one or more of: a search engine, a desktop application, and a website.

In additional method embodiments, the method further comprises outputting the one or more results on a display interface of the user device, the display interface comprising one or more side by side windows. Further, the each of the one or more side by side windows display the one or more results associated with the first user interface element and a second user interface element respectively, from the plurality of user interface elements.

In one aspect of system claims, a system for performing a search is disclosed. The system comprises a memory configured to store computer-executable instructions and at least one processor configured to execute the computer-executable instructions. The computer executable instructions configured to: obtain a search query from a user. Further, the at least one processor is further configured to receive user selection corresponding to a first user interface element from a plurality of user interface elements, the user selection is performed on a keyboard based navigation. Each of the plurality of user interface elements is associated with a corresponding URL. The at least one processor is further configured to generate one or more results for the search query based on the received user selection; and output the one or more results corresponding to the search query.

In additional system embodiments, the at least one processor is further configured to perform the search by accessing a search interface by pressing a key of a keyboard device of the user, where the search interface consists of a search window to display information associated with the search query. Further, the key to the keyboard device is esc key associated with the user device.

In additional system embodiments, the keyboard-based navigation is further based upon navigating using at least one of: an up arrow key, a down arrow key, a left arrow key, and a right arrow key; of the keyboard device associated with the user device.

In additional system embodiments, the URL corresponding to user interface elements is configured by the user based on a settings user interface. The settings user interface further comprises configuration options associated with one or more of: a window length, a window width, and one or more advertising preferences.

In additional system embodiments, the plurality of user interface elements are further associated with one or more of: search engine, desktop application, websites, and the like.

In additional system embodiments, the at least one processor is further configured to output the one or more results on a display interface of the user device, the display interface comprising one or more side by side windows, wherein the each of the one or more side by side windows display the one or more results associated with the first user interface element and a second user interface element respectively, from the plurality of user interface elements.

In yet another aspect, a computer program product comprising a non-transitory computer readable medium having stored thereon computer executable instructions is provided. The computer executable instructions, when executed by at least one processor, cause the at least one processor to carry out operations for performing a search, the operation comprising: obtaining a search query from a user; receiving user selection corresponding to a first user interface element from a plurality of user interface elements, where the user selection is performed via a keyboard based navigation; generating one or more results for the search query based on the received user selection; and outputting the one or more results corresponding to the search query.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the present disclosure in general terms, reference will now be made to the accompanying drawings, which are not necessarily drawn to scale, and wherein:

FIG. 1 illustrates a network environment diagram of a system for performing a search, in accordance with some embodiments of the present disclosure;

FIG. 2 illustrates a block diagram of a search interface of an exemplary user device, in accordance with some embodiments of the present disclosure;

FIG. 3 illustrates a settings user interface for configuring search options for the search interface shown in FIG. 2, in accordance with some embodiments of the present disclosure;

FIG. 4A illustrates a display interface of the exemplary user device of the system for displaying search results, in accordance with some embodiments of the present disclosure;

FIG. 4B illustrates another display interface of the exemplary user device of the system for displaying the search results, in accordance with some embodiments of the present disclosure;

FIG. 5 illustrates an exemplary search interface for performing search conveniently, in accordance with some embodiments of the present disclosure;

FIG. 6 illustrates a flow diagram of a method for performing search, in accordance with some embodiments of the present disclosure;

FIG. 7 illustrates a flow diagram of another method for performing search, in accordance with some embodiments of the present disclosure; and

FIG. 8 illustrates a block diagram of a user device, in accordance with some embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity but denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the present disclosure are shown. Indeed, various embodiments of the present disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus (or a system) to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Some embodiments are based on a realisation that if an individual wants to perform repeated and multiple searches using different search engines, the process of typing a search query, hitting enter or performing mouse-click and checking search results, has to be repeated multiple times. This requires a lot of manual efforts of going back and forth on different search engines for the purpose of online search. The individuals always prefer to perform efficient search to save time and efforts. However, the existing methods are time consuming and inefficient. The present disclosure discloses a system which addresses aforementioned problems with existing web search methods, as well as offline searching methods.

The various embodiments described herein are configured for operation using any browser based and non-browser based searching applications, using an advanced search interface described herein. To that end, some embodiments provide methods and systems for obtaining a search query from a user. Further, a user selection is obtained corresponding to a user interface element from a plurality of user interface elements. The user selection is performed on a keyboard based navigation, where each of the plurality of user interface elements is associated with a corresponding URL. Further, one or more results are generated for the search query based on the received user selection and the one or more results corresponding to the search query are displayed as output at the search interface. The various embodiments will now be explained in detail, with reference to accompanying figures as outlined below.

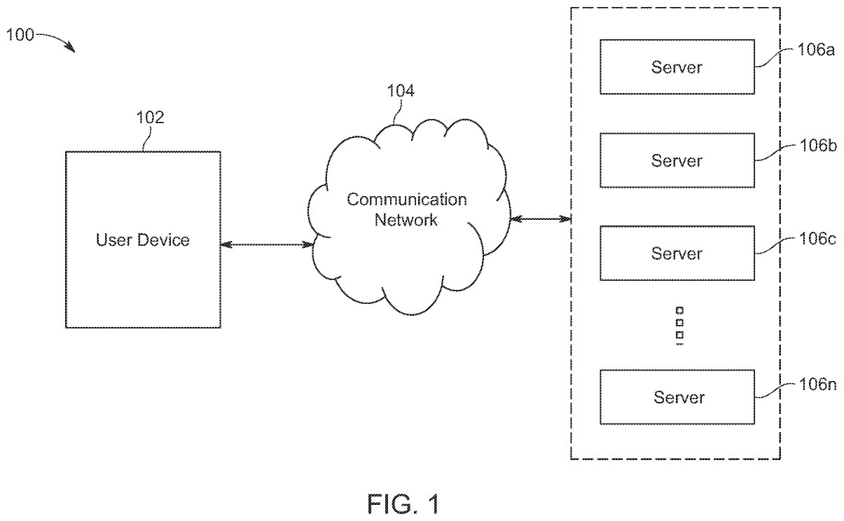

FIG. 1 illustrates a network environment diagram of a system 100, in accordance with some embodiments of the present disclosure. The system 100 comprises a user device 102, a communication network 104, and a plurality of servers 106a, 106b, . . . 106n. The user device 102, and the plurality of servers 106a, 106b, . . . 106n may be communicatively coupled with each other via the communication network 104.

User device 102 may comprise suitable logic, circuitry, and interfaces that may be configured to execute various operations in the system 100 such as providing a search interface, generating search results, outputting search results and the like. The examples of the user device 102 may include, but are not limited to, a mobile phone, a portable computer, a desktop computer, a laptop, a tablet, a personal digital assistant (PDA), and the like.

The communication network 104 may comprise suitable logic, circuitry, and interfaces to establish communication between the user device 102 and the plurality of servers 106a, 106b, . . . 106n. In some embodiments, data transferred via the communication network 104 may be in the form of signals, which may be electronic, electromagnetic, radio, or other types of signals. To that end, the communication network 104 may be wired, wireless, or any combination of wired and wireless communication networks, such as cellular, Wi-Fi, internet, local area networks, or the like. In one embodiment, the communication network 104 may include one or more networks such as a data network, a wireless network, a telephony network, or any combination thereof. It is proposed that the data network may be any local area network (LAN), a wide area network (WAN), a wireless local area network (WLAN), a system area network (SAN), a public data network (e.g., the internet), a short range wireless network, or any other suitable packet-switched network, such as a commercially owned, proprietary packet-switched network, e.g., a proprietary cable or fiber-optic network, and the like, or any combination thereof.

In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), long term evolution (LTE) networks (for e.g. LTE-Advanced Pro), 5G New Radio networks, code division multiple access (CDMA), wideband code division multiple access (WCDMA), wireless fidelity (Wi-Fi), wireless LAN (WLAN), Bluetooth, Internet Protocol (IP), satellite, mobile ad-hoc network (MANET), and the like, or any combination thereof.

The plurality of servers 106a, 106b, . . . 106n may be associated with one or more web based applications, desktop applications, cloud based applications, and the like. For example, the servers 106a, 106b, . . . 106n, may include a server, such as the server 106a, hosting a web search engine such as Google, Microsoft Bing, Yahoo, Baidu, and the like. Additionally, the servers 106a, 106b, . . . 106n, may include a server, such as the server 106b, hosting a website of user's choice such as Amazon, Facebook, Reddit, Wikipedia, and the like.

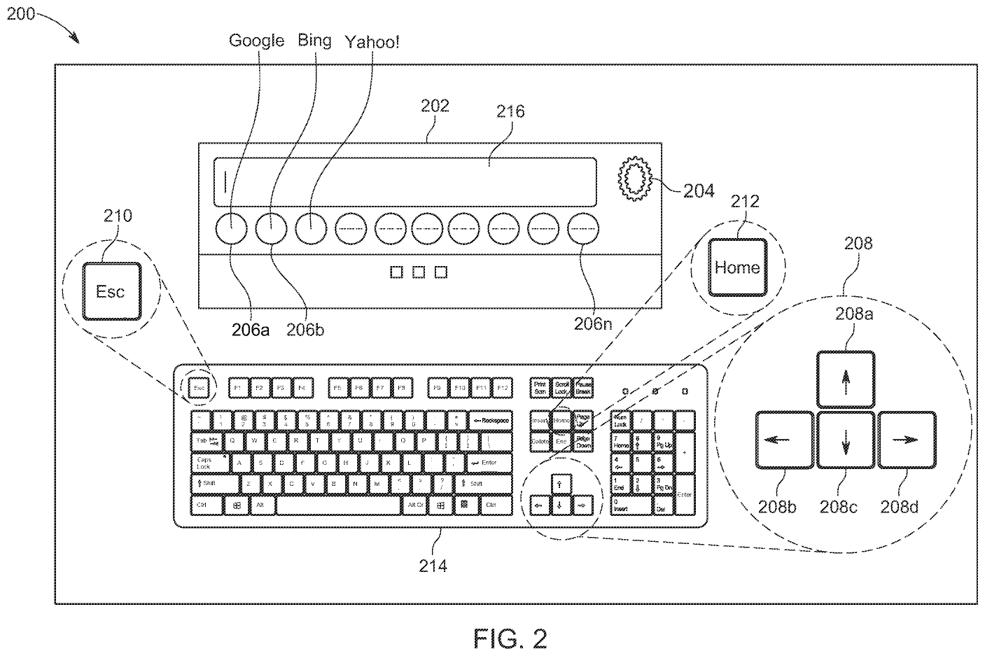

In some embodiments, the servers 106a, 106b, . . . 106n, may include a server, such as the server 106c, associated with an enterprise software tool that employees of an organization can use for immediate access to important files, presentations, whitepapers, webinars, and the like. Thus, the plurality of servers 106a, 106b, . . . 106n may be any one among, but not limited to, search engine, website, or software tool where user wants to go for the immediate pulling of valuable information. The plurality of servers 106a, 106b, . . . 106n may comprise suitable logic, circuitry, and interfaces to execute various operations such as processing the data obtained from the user device 102 via the communication network 104, generating one or more results related to a search query and controlling different operations based on a result of the analysis of the data. Components and working of the user device are described in detail in FIG. 2, in accordance with the present disclosure.

FIG. 2 illustrates a block diagram of a search interface of an exemplary user device 200, in accordance with some embodiments of the present disclosure. The exemplary user device 200 comprises a search interface 202, a plurality of user interface elements 206a, 206b, . . . 206n, a settings icon 204, and one or more arrow keys 208 comprising an up arrow key 208a, a left arrow key 208b, a down arrow key 208c, and a right arrow key 208d. The arrow keys are part of a keyboard device 214 of the user using the user device 200. The keyboard device 214 may be included with the user device 200 or may be additionally attached to the user device 200. The keyboard device 214 further includes an “esc” key 210 and a home key 212. Pressing the esc key 210 of the keyboard device 214 leads to popping up or accessing of a search window 216 associated with access of the search interface 202.

As illustrated in FIG. 2, the search interface 202 includes the plurality of user interface elements 206a, 206b, . . . 206n. Each of the plurality of user interface elements 206a, 206b, . . . 206n may comprise one or more of: a button, a label, and an icon. For example, in the exemplar search interface 202, each of the plurality of user interface elements 206a, 206b, . . . 206n is a button. Similarly, any other type of user interface element performing the same functionality as a button may be used, without deviating from the scope of the present disclosure.

Further, each of the plurality of user interface elements 206a, 206b, . . . 206n are associated with one or more of: a search engine application, a desktop application, a website, and the like. For example, the labels displayed on each of the plurality of user interface elements 206a, 206b, . . . 206n may correspond to the backend application that can be accessed using these user interface elements. The backend applications are associated with either user device 200 based data or with one or more of the plurality of servers 106a, 106b, . . . 106n described earlier.

For example, when each of the plurality of user interface elements 206a, 206b, . . . 206n display labels corresponding to one or more web search engines such as Google, Microsoft Bing, Yahoo, Baidu etc., then the corresponding user interface element from the plurality of user interface elements 206a, 206b, . . . 206n is associated with an associated server hosting that web search engine. Similarly, when each of the plurality of user interface elements 206a, 206b, . . . 206n display labels corresponding to one or more websites other than a web search engine, like Amazon, Facebook, Reddit, Wikipedia etc; or a desktop application such as Outlook, Gmail, Microsoft Teams etc; then the corresponding user interface element from the plurality of user interface elements 206a, 206b, . . . 206n is associated with an associated server hosting that website or the desktop application respectively.

When the user accesses the search interface 202 by pressing the “esc” key 210 on the keyboard device 214, the search window 216 showing a cursor for typing a search query appears in the search interface. The user may then type the search query in the search window 216. Further, the user may select one of the plurality of user interface elements 206a, 206b, . . . 206n, via a keyboard based navigation. Further, “esc” key is just an example implementation. Also, there are many other special tasks that may be performed by pressing “esc” in a user device for various purposes. Further, while using the “esc” key for the purpose of accessing the search interface, the “esc” key will function without interfering with the use of the “esc” key for other purposes that exist in the user device. In practice, any other key from the keyboard may be used to for implementing the functionality provided by the “esc” key as described, without deviating from the scope of the disclosure provided.

In an example embodiment, user selects a preferred user interface element by navigating in directions such as up, down, left, and right on the plurality of user interface elements 206a, 206b, . . . 206n and other components of the search interface 202. This navigation is done using the arrow keys 208 of the keyboard device 214 for performing the keyboard-based navigation. For example, using the up arrow key 208a, the user may see the history of previous searches performed by the user. Similarly, using the down arrow key 208c, the user may select the next search in the search history. Using the left arrow key 208b, the user may navigate in the left direction on the plurality of user interface elements 206a, 206b, . . . 206n; and using the right arrow key 208d, the user may navigate in the right direction on the plurality of user interface elements 206a, 206b, . . . 206n.

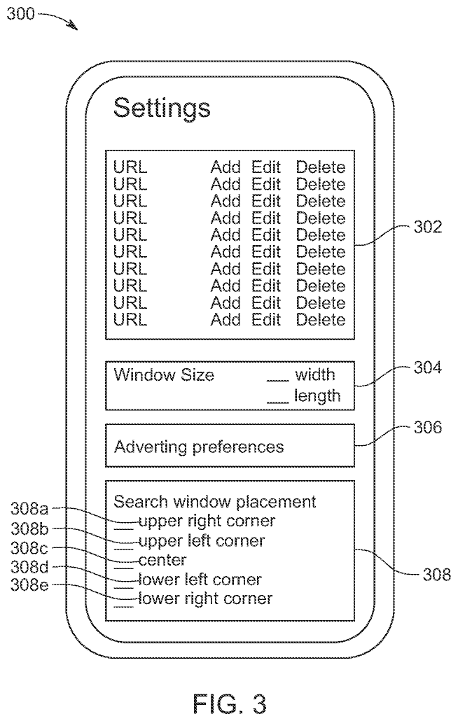

Additionally, using the settings icon 204, the home page of the search interface 202 may be set according to user's choice. The user may press the home key 212 to come out of a search result window. The home key 212 is used to return users to their default page, the same page that loads when the search interface is first opened. The user may configure search options for the search interface 202, window size and advertising preferences using the settings icon 204. The functionality of settings icon 204 is described in detail in FIG. 3.

FIG. 3 illustrates a setting user interface 300 for configuring search options for the search interface 202 shown in FIG. 2, in accordance with some embodiments of the present disclosure. The search interface 202 comprises the settings icon 204 as discussed in FIG. 2. The settings icon 204 further comprises a link to the settings user interface 300, where multiple configuration options associated with one or more of a window length, a window width, a search window placement, and advertising preferences are set for the search interface 202. The setting user interface 300 comprises a configuration option for a Uniform Resource Locator (URL) configuration setting 302. The setting user interface 300 comprises another configuration option for a window configuration setting 304 where a window length and a window width associated with the search interface 202 length and width respectively can be configured. The setting user interface 300 comprises a configuration option for an advertising settings 306, where advertising preferences for displaying on the search interface 202 are set. The setting user interface 300 comprises a configuration option for a search window placement 308 where the search window can be configured to be placed at one among, an upper right corner 308a, an upper left corner 308b, center 308c, a lower left corner 308d and a lower right corner 308e. The settings icon 204 allows users to adjust their user preferences, configure the search interface, the search window placement and the window size of the search interface 202 is some examples.

To that end, the URL configuration setting provides options to add, delete or edit a URL address of a given unique resource on web. The URL incorporates a domain name, along with other detailed information, to create a complete address (or “web address”) to direct the user to a web page. The URL is a set of directions and every web page has a unique one. In some example embodiments, each of the plurality of user interface elements 206a, 206b,206n, is associated with a corresponding URL. Further, the corresponding URL may be configured using the URL configuration settings 302. For example, the user may configure the URL of Google.com for the user interface element 206a, the user may configure the URL of bing.com for the user interface element 206b, and the like. Likewise, any other website, application, or desktop based utility may be configured on any user interface element using the URL configuration settings 302.

In the window configuration settings 304, configuration options are available associated with one or more of: a window length, a window width.

In advertising settings 306, the users can add advertising preference according to their choices. For example, which advertisements to display, where to display and the like.

In search window placement 308, configuration options are available for placement of the search window at one of the positions: upper right corner, upper left corner, center, lower right corner and lower left corner.

After configuring the settings for the search interface 202, the user performs the search, whose results are displayed on the user device.

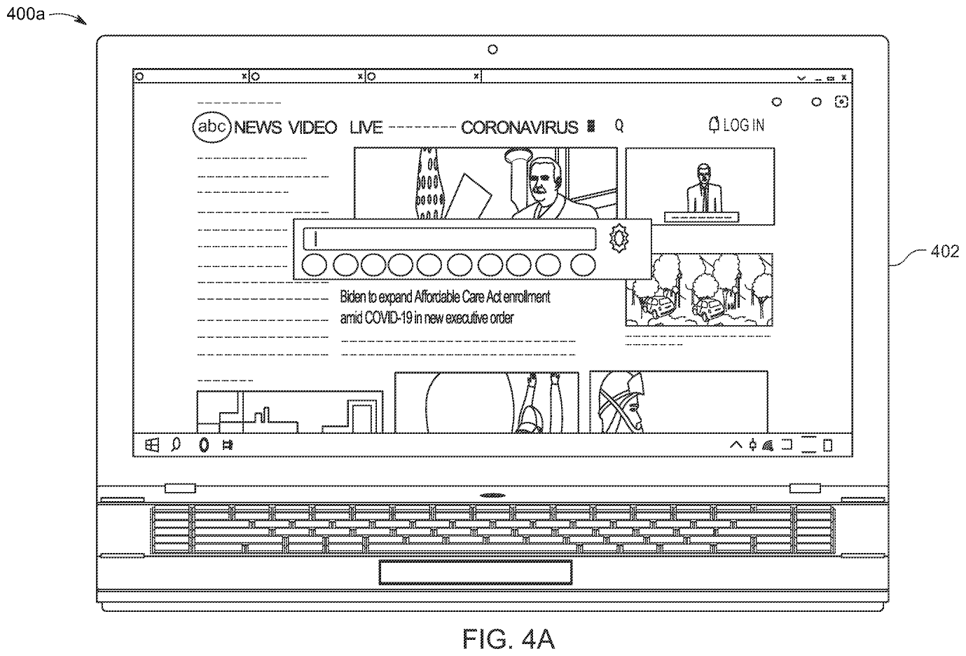

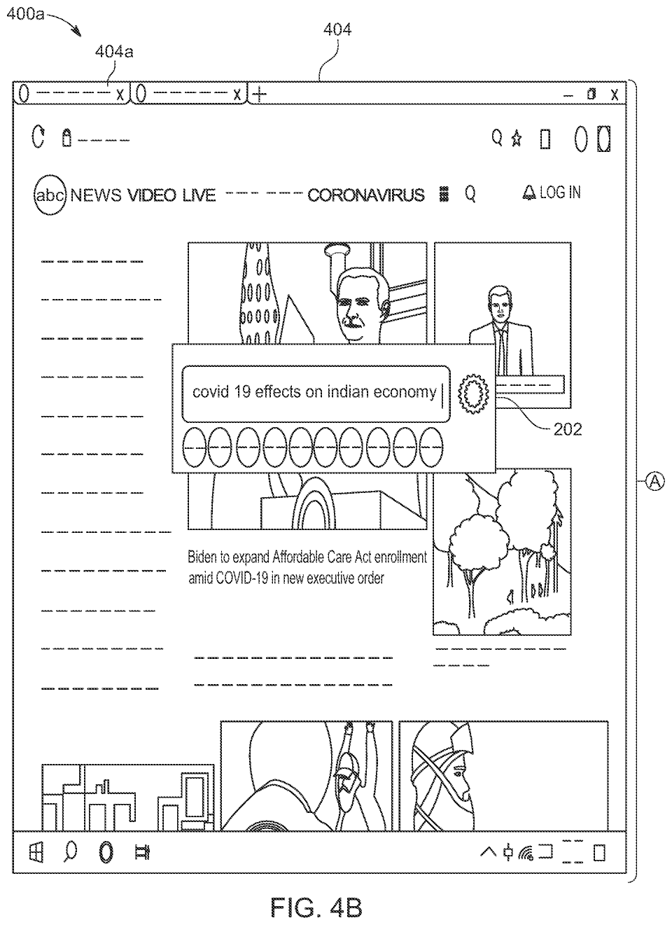

FIG. 4A illustrates a display interface 402 of an exemplar user device 402a of the system 100 for displaying search results, in accordance with some embodiments of the present disclosure. The exemplar user device 400a is equivalent to the user device 102 shown in FIG. 1. The user device 402a comprises a display interface 402 displaying the search results associated with a search query received from the user on the search interface 202. The display interface 402 can be one among, but not limited to, a Liquid crystal display (LCD), a Light-emitting diode (LED) display, an Organic Light-emitting diode OLED display, an Active Matrix Light-emitting diode AMOLED display, a Super AMOLED display and the like. Some embodiments are based on a realisation that in order to perform a search, a search query is obtained from a user. The search query is obtained on the search window 216 of the user device 402a. In some example embodiments, the search interface 202 is accessed by pressing the “esc” key of the keyboard device of the user which is provided with the user device 400a by way of example illustrated herein. Further, one or more results are generated corresponding to the search query obtained on the search window 216 of the user device. The one or more results are displayed on the display interface 402 of the user device 400a.

FIG. 4B illustrates another display interface 404 of the exemplar user device 400a of the system 100 for displaying the search results, in accordance with some embodiments of the present disclosure. The display interface 404 displays two side by side windows, a first window 404a and a second window 404b placed adjacent in length to achieve the side by side window placement for example. However, any other suitable placement, and any number of display windows may be configured, without deviating from the scope of the present disclosure.

The side by side windows 404a and 404b show one or more results associated with the first user interface element 206a and the second user interface element 202b respectively, from the plurality of user interface elements 206, in an example. In some example embodiment, the search results are displayed on the display interface 404 of the user device. The display interface 404 allows the user to open multiple pages at the same time, in different windows. Further, the one or more search results may be displayed using a multiple frames interface (MFI). The multiple frames interface (MFI) is a type of user interface which displays information in a set of frames or panels that can be scrolled vertically on a screen. It is an integrated interface designed to bring together virtually all the search results onto a single screen.

Such a display allows the user to conveniently perform, view and compare the search results obtained using different search tools, such as search engines.

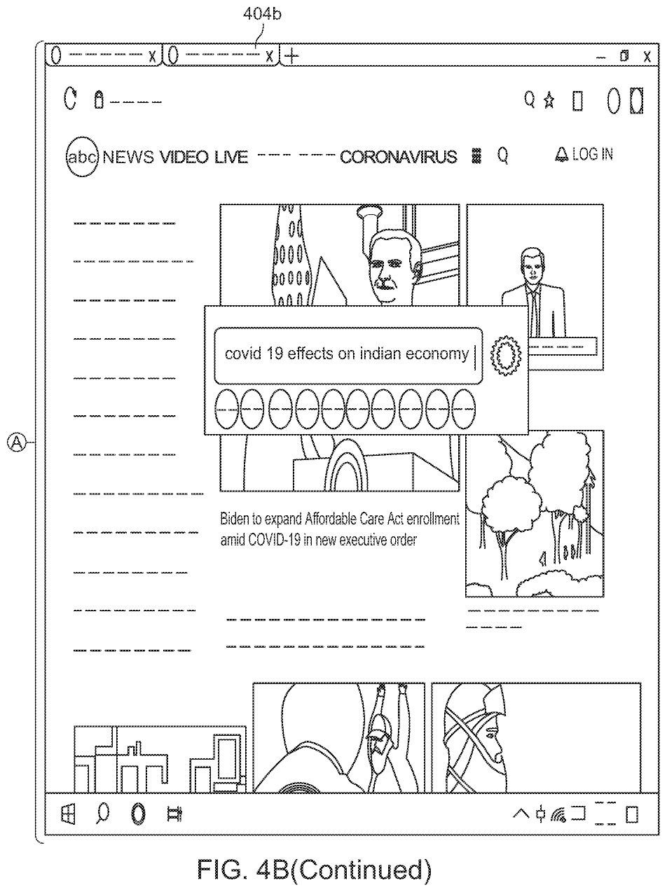

FIG. 5 illustrates an exemplar search interface 500 for performing search conveniently, in accordance with some embodiments of the present disclosure. The exemplar search interface 500 comprises the search interface 202, as discussed in FIG. 2 and an advertising window 502. The search interface 202 comprises plurality of user interface elements 206a, 206b, . . . 206n, a settings icon 204 and a search window 216 (as shown previously). In the advertising window 502, advertisements may be associated with text, banners, push notifications and pre or post-roll video ads. Advertisements enable businesses of all sizes, from around the world, to promote a wide variety of products, services, applications, and websites. However, to help create a safe and positive experience for users, users may give feedback and concerns about the types of ads they see. Additionally, a set of policies may be created that apply to all the advertisements. It is required that advertisers comply with all applicable laws and the set of policies. If any content that violates the set of policies, the users may block it from appearing.

To that end, the advertisements, advertisers and their associated privacy and access data may be configured using the one or more advertising preferences setting 306 from the setting user interface 300 discussed previously in FIG. 3.

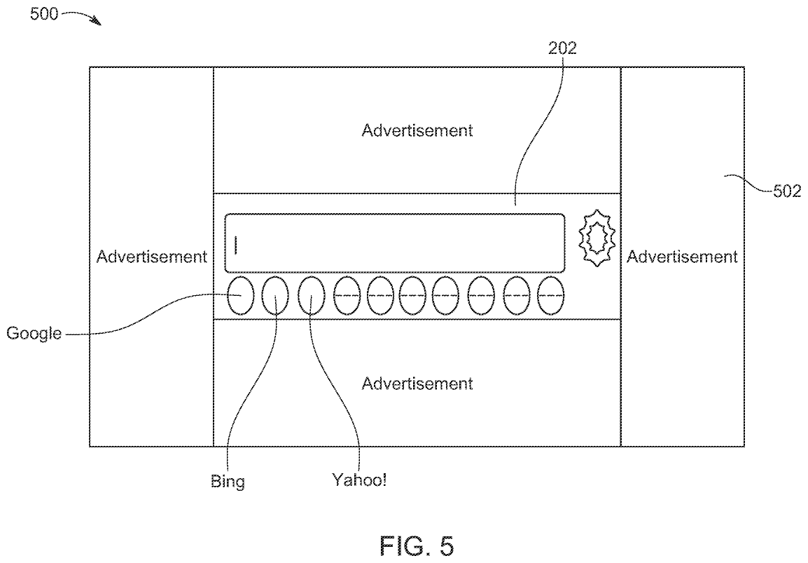

FIG. 6 illustrates a flow diagram of a method 600 for performing search, in accordance with some embodiments of the present disclosure. The operations start at step 602. At step 602, a search query is obtained from a user. The search query includes words that a user may type into the search window 216 in order to get information from the internet or from their user device. At step 604, user selection is received corresponding to a first user interface element from a plurality of user interface elements. The plurality of user interface elements 206a, 206 b, . . . 206n, as discussed in FIG. 2, may be associated with one or more of: a search engine application, a desktop application, and a website. The user interface elements 206a, 206b, . . . 206n may further be associated with a search engine such as Google, Microsoft Bing, Yahoo, Baidu etc., a website such as Amazon, Facebook, Reddit, Wikipedia etc. or a desktop application such as Outlook, Gmail, Microsoft Teams, and the like. The user selection may be obtained using keyboard based navigation as discussed in FIG. 2. At step 606, one or more results are generated for the search query based on the received user selection. For example, if the user selects the user interface element corresponding to label Google displayed on it, the search query of the user is linked to the google.com search page and server, and search results from google.com are generated for displaying to the user.

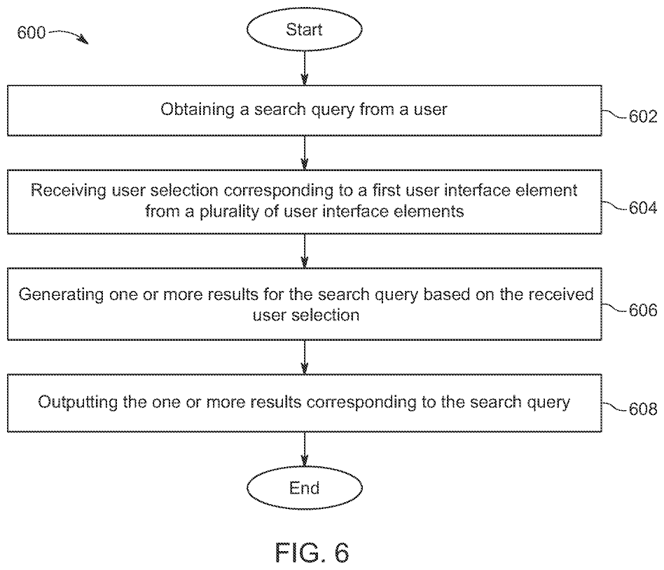

At step 608, one or more results are displayed to user. The one or more search results are displayed on display interface, such as the display interface 402 or 404 illustrated in FIG. 4A or FIG. 4B previously. Operations for accessing the search interface and for configuring the system 100, are further described in FIG. 7.

FIG. 7 illustrates a flow diagram of another method 700 for performing search, in accordance with some embodiments of the present disclosure. The operations start at step 702. At step 702, the search interface 202 is accessed by pressing a key of the keyboard device of the user. Further, user selection is received corresponding to a first user interface element from a plurality of user interface elements, where user selection is performed based on a keyboard based navigation.

At step 704, user navigates up, down, left, and right using corresponding arrow keys of the keyboard device for performing the keyboard-based navigation. This is done using at least one of: an up-arrow key, a down arrow key, a left arrow key, and a right arrow key; of the keyboard device for performing the keyboard-based navigation, as illustrated in FIG. 2. The keyboard based navigation is enabled using one or more user interface elements, such as user interface elements 206.

In some example embodiments, each of the plurality of user interface elements is associated with a corresponding URL. At step 706, URL based configuration is done on a settings user interface, for configuring the corresponding URL based on options provided in the settings user interface. Such a settings user interface is illustrated in FIG. 3.

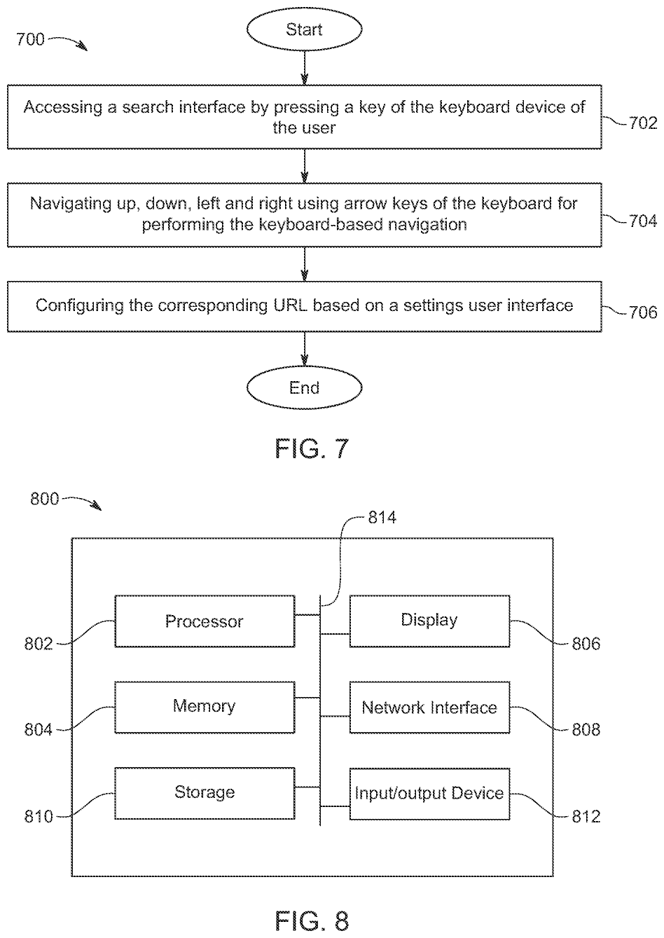

Thus, using the method 700 described above, any URL, be it related to a web based application or a desktop based application, may be configured for ease access on the user's associated user device. Such a user device is illustrated as the user device 102 in FIG. 1, user device 200 in FIG. 2 and the user device 400a in FIG. 4, which are all equivalent in functions. The capabilities of such a user device are further described below in conjunction with FIG. 8.

FIG. 8 illustrates a block diagram of a user device 800, in accordance with some embodiments of the present disclosure. The user device 800 may include a processor 802, a memory 804, a display 806, a network interface 808, a storage 810, and an input/output device 812, which are coupled with each other via a bus 814.

The processor 802 may comprise suitable logic, circuitry, and interfaces to execute computer-executable instructions stored in the memory 804. In some embodiments, the processor 802 may be embodied as one or more of various processing means such as a microprocessor, a controller, a digital signal processor (DSP), application specific system processor (ASSP), or various other processing circuitry including integrated circuits such as, for example, an application specific integrated circuit (ASIC), a field programmable gate array (FPGA), a microcontroller unit (MCU), a special-purpose computer chip, or the like. As such, in some embodiments, the processor 802 may include one or more processing cores configured to perform independently. A multi-core processor may enable multiprocessing within a single physical package. Additionally or alternatively, the processor 802 may include one or more processors configured to perform independent execution of instructions, pipelining and/or multithreading. Additionally or alternatively, the processor 802 may include one or more processors capable of processing large volumes of data and operations to provide support for big data analysis. Alternatively, as another example, the processor 802 is embodied as an executor of software instructions, the instructions may specifically configure the processor 802 to perform the algorithms and/or operations described herein when the instructions are executed.

The processor 802 may include, among other things, a clock, an arithmetic logic unit (ALU), registers, buses and logic gates configured to support operation of the processor 802. Additionally, the processor 802 may be configured to execute various operations in the system 100 such as providing a search interface, generating search results, outputting search results and the like.

The memory 804 may comprise suitable logic, circuitry, and interfaces to store user data, and computer-executable instructions which are executed by the processor 802. The memory 804 may be non-transitory and may include, for example, one or more volatile and/or non-volatile memories. In other words, for example, the memory 804 may be an electronic storage device (for example, a computer readable storage medium) comprising gates configured to store data (for example, bits) that may be retrievable by a machine (for example, a computing device like the processor 802). The memory 804 may be configured to store information, data, content, applications, instructions, or the like, for enabling the processor 802 to carry out various functions in accordance with an example embodiment of the present disclosure. The memory 804 may be configured to store the like data corresponding to each user of the first set of users received from the plurality of remote data sources. Further, the memory 804 may be configured to buffer input data obtained from an input/output device 812 for processing by the processor 802.

The input/output (I/O) device 812 may comprise suitable logic, circuitry, and interfaces to receive user inputs and output data based on a result of analysis of data by the processor 802. Examples of the I/O device may include, but are not limited to, a keyboard device, a mouse, and the like configured to receive, process, and output data. The display 806 may include a touch based display screen, a display device, a monitor, and the like. The storage 810 may include suitable logic, circuitry, and interfaces to store user search data, user search history and data associated with plurality of user interface elements 206a, 206b . . . , 206n.

The network interface 808 may comprise suitable logic, circuitry, and interfaces to enable communication between the user device 102 and the plurality of servers 106a, 106b, . . . 106n over the communication network 104. In some embodiments, the network interface 808 may be a network interface card (NIC) which is a hardware component, typically a circuit board or chip, which is installed on a hardware of the user device 102 so that the user device can connect to the communication network 106. Further, the network interface 808 also provides functionalities, such as support for I/O interrupt, direct memory access (DMA) interfaces, data transmission, network traffic engineering and partitioning. The network interface 808 provides a resolute, full-time connection to the communication network 106. It implements the physical layer circuitry necessary for communicating with a data link layer standard, such as Ethernet or Wi-Fi. Each card represents a device and can prepare, transmit and control the flow of data on the communication network 106.

It will be understood that each block of the flow diagram of the method 600 and the method 700 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 804 of the user device 800, employing an embodiment of the present invention and executed by the processor 802. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram 600 and the flow diagram 700 support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

The claimed invention is:

1. A method for performing a search, the method comprising:
obtaining a search query from a user;
receiving user selection corresponding to a first user interface element from a plurality of user interface elements, wherein the user selection is performed via a keyboard based navigation performed using a keyboard device of the user;
generating one or more results for the search query based on the received user selection; and
outputting the one or more results corresponding to the search query.

2. The method of claim 1, wherein each of the plurality of user interface elements is associated with a corresponding URL.

3. The method of claim 2, further comprising:
configuring the corresponding URL based on a settings user interface.

4. The method of claim 3, wherein the settings user interface comprises configuration options associated with one or more of: a window length, a window width, and advertising preferences.

5. The method of claim 1, further comprising:
accessing a search interface by pressing a key of the keyboard device of the user, wherein the search interface comprises a search window to display information associated with the search query.

6. The method of claim 5, wherein the key is “esc” key associated with the keyboard device.

7. The method of claim 1, further comprising:
navigating using at least one of: an up arrow key, a down arrow key, a left arrow key, and a right arrow key; of the keyboard device for performing the keyboard-based navigation.

8. The method of claim 1, wherein each of the plurality of user interface elements comprises one or more of: a button, a label, and an icon.

9. The method of claim 8, wherein each of the plurality of user interface elements are associated with one or more of: a search engine application, a desktop application, and a website.

10. The method of claim 1, further comprising:
outputting the one or more results on a display interface of the user device, the display interface comprising one or more side by side windows, wherein the each of the one or more side by side windows display the one or more results associated with the first user interface element and a second user interface element respectively, from the plurality of user interface elements.

11. A system for performing a search, the system comprising:
a memory configured to store computer-executable instructions; and
at least one processor configured to execute the computer-executable instructions to:
obtain a search query from a user;
receive user selection corresponding to a first user interface element from a plurality of user interface elements, wherein the user selection is performed via a keyboard based navigation performed using a keyboard device of the user;
generate one or more results for the search query based on the received user selection; and
output the one or more results corresponding to the search query.

12. The system of claim 11, wherein each of the plurality of user interface elements is associated with a corresponding URL.

13. The system of claim 12, wherein the at least one processor is further configured to: configure the corresponding URL based on a settings user interface.

14. The system of claim 13, wherein the settings user interface comprises configuration options associated with one or more of: a window length, a window width, and one or more advertising preferences.

15. The system of claim 11, wherein the at least one processor is further configured to:
access a search interface by pressing a key of the keyboard device of the user, wherein the search interface comprises a search window to display information associated with the search query.

16. The system of claim 11, wherein the at least one processor is further configured to: navigate using at least one of: an up arrow key, a down arrow key, a left arrow key, and a right arrow key; of the keyboard device for performing the keyboard-based navigation.

17. The system of claim 11, wherein each of the plurality of user interface elements comprises one or more of: a button, a label, and an icon.

18. The system of claim 17, wherein each of the plurality of user interface elements are associated with one or more of: a search engine application, a desktop application, and a website.

19. The system of claim 11, wherein the at least one processor is further configured to:
output the one or more results on a display interface of the user device, the display interface comprising one or more side by side windows, wherein the each of the one or more side by side windows display the one or more results associated with the first user interface element and a second user interface element respectively, from the plurality of user interface elements.

20. A computer program product comprising a non-transitory computer readable medium having stored thereon computer executable instruction which when executed by at least one processor, cause the at least one processor to conduct operations for performing a search, the operations comprising:
obtaining a search query from a user;
receiving user selection corresponding to a first user interface element from a plurality of user interface elements, wherein the user selection is performed via a keyboard based navigation performed using a keyboard device of the user;
generating one or more results for the search query based on the received user selection; and
outputting the one or more results corresponding to the search query.
